(19) United States
(12) Patent Application Publication
(10) Pub. No.: US 2015/0197715 A1
(43) Pub. Date: Jul. 16, 2015

(54) WHISKEY STICKS

(71) Applicant: Tony PENICHE, Portland, OR (US)

(72) Inventor: Tony PENICHE, Portland, OR (US)

(21) Appl. No.: 14/593,158

(22) Filed: Jan. 9, 2015

Related U.S. Application Data
(60) Provisional application No. 61/925,786, filed on Jan. 10, 2014.

(51) Int. Cl. C12G 3/07

(52) U.S. Cl. CPC C12G 3/065

(57) ABSTRACT

A whisky bottle has a volume of liquid whisky and contains at least one piece of wood cut from a used whisky barrel and/or a wine barrel used to distill whiskey, where the at least one piece of wood has a total surface area thereof that is selected based upon the volume of liquid.

### CROSS-REFERENCE TO RELATED APPLICATIONS

This application claims the benefit of U.S. Provisional App. No. 61/925,786, filed Jan. 10, 2014.

### BACKGROUND OF THE INVENTION

The present invention relates to whiskey spirits.

Whisky (or whiskey) or whisky-like is a distilled alcoholic beverage made from fermented grain mash Different grains are used for different varieties, including for example, barley, malted barley, rye, malted rye, wheat, and corn. Often the whiskey is aged in wooden casks, generally made of charred white oak. The typical unifying characteristics of different classes and types are the fermentation of grains, distillation, and aging in wooden barrels.

The whisky or whisky-like products often differ in their base product, alcoholic content, and quality.

Malt whisky is made primarily from malted barley. Single malt whisky is made from a single distillery made from a mash that uses only one particular malted grain. Often the single malt whisky is made from whisky from many casks and different years, so that the blender can achieve a taste recognizable as typical of the distillery.

Blended malt whisky is a mixture of a single malt whisky from different distilleries. Often the blended malt whisky can vary in taste by the blender selecting which whisky to mix together and the amounts thereof.

Blended whiskies are made from a mixture of different types of whisky. A blend may contain whisky from many distilleries so that the blender can produce a flavor consistent with the general desire, although can vary based upon the blender.

Cask strength, also generally known as barrel proof, whiskies are bottled from the cask undiluted or only lightly diluted. Generally, these are considered a higher quality whisky, and can vary based upon the blender

Single cask, also generally known as single barrel, whiskies are bottled from an individual cask. The taste of such whiskies may vary substantially from cask to cask, even when done by the same blender using a consistent technique.

Whiskies do not age within the bottle, but rather within the cask, so the age of a whisky is the time between distillation and bottling. This reflects how much the cask has interacted with the whisky, changing its chemical makeup and taste. Whiskies that have been bottled for many years may have a rarity value, but are not older and not necessarily better than a more recent whisky that matured in wood for a similar time.

The flavoring of whisky is partially determined by the presence of congeners and fusel oils. Fusel oils are higher alcohols than ethanol and are mildly toxic, and have a strong, disagreeable smell and taste. An excess of fusel oils in whisky is considered a defect. A variety of methods are employed in the distillation process to remove unwanted fusel oils. Also, whisky that has been aged in oak barrels absorbs substances from the wood. One of these is cis-3-methyl-4-octanolide, known as whisky lactone, a compound with a strong coconut aroma. The flavoring process of whisky is thus highly dependent on the time and the techniques used by the blender.

Unfortunately, in addition to the variations of the blender, the taste tends to vary significant especially based upon the age that comes from the barrel.

### BRIEF DESCRIPTION OF THE SEVERAL VIEWS OF THE DRAWINGS

FIG. 1 illustrates a whisky barrel.

FIG. 2 illustrates a whisky bottle.

FIG. 3 illustrates a technique for modifying a whisky bottle.

### DETAILED DESCRIPTION OF PREFERRED EMBODIMENT

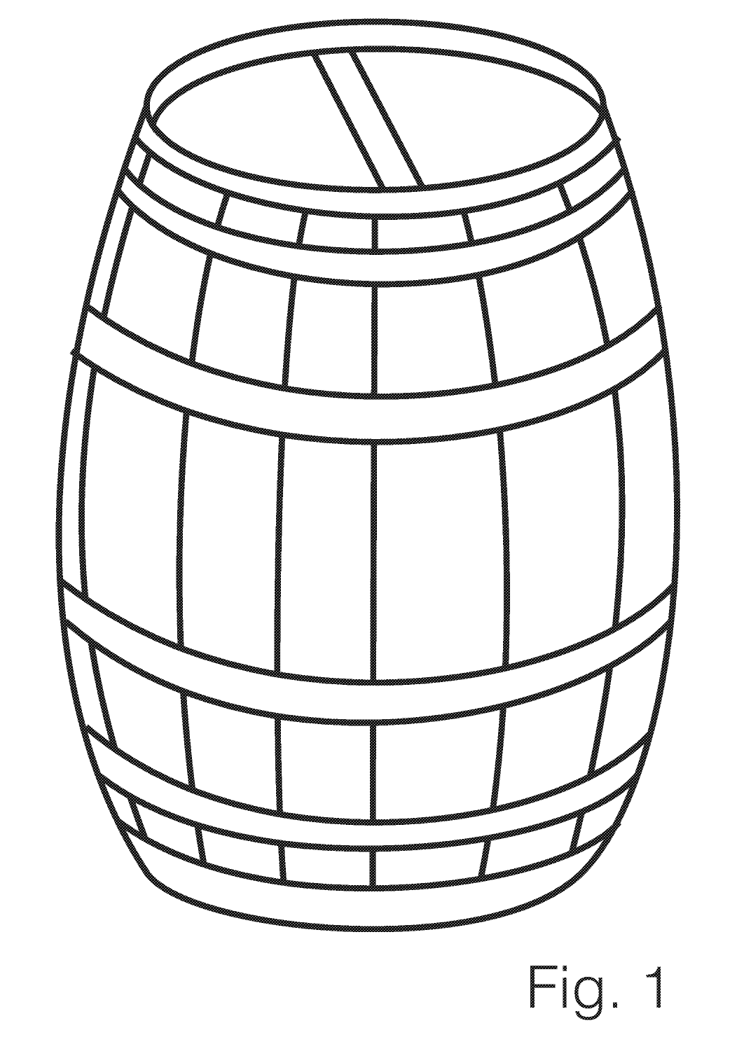

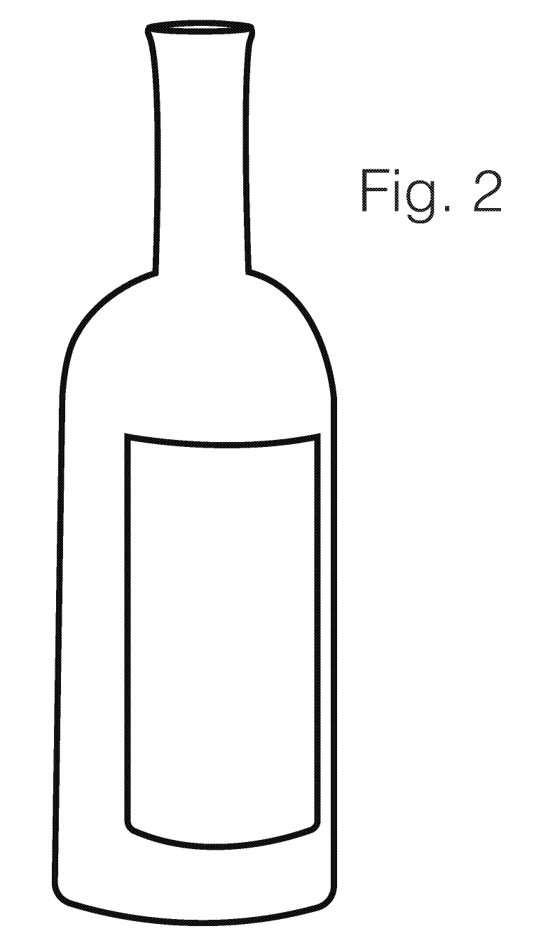

Referring to FIG. 1, a whisky barrel is made out of wood, typically in a generally cylindrical shape. The whisky ages in the barrel over a number of years, such as 3 years, 5 years, 10 years, and 20 years. As a general matter, the longer the whisky ages in the barrel the better the whisky becomes. However, whisky that has aged a large number of years tends to be substantially more expensive than whisky that has aged a limited number of years. Referring to FIG. 2, after the whisky has sufficiently aged in the barrel, the whisky is bottled in bottles for distribution and sale to customers.

After consideration of the aging process of whisky it was determined that the surface area of the barrel relative to the volume enclosed within the barrel is a contributing factor to the aging process of the whisky. In addition, having a greater surface area relative to the volume tends to decrease the time required for adequate aging for sufficiently good flavor and color. For example, a whisky barrel may have a capacity of 31 gallons, 59 gallons, or 79 gallons. The surface area of the barrel is generally, the surface area of the bases (2*π*radius²) plus the surface area of the lateral sides (diameter*π*height). For example, a 26 gallon barrel may have a surface area of 2,000 square inches, a surface to volume ratio of ˜80 (square inches/volume in gallons). For example, a 59 gallon barrel may have a surface area of 6,500 square inches, surface to volume ratio of ˜110 (square inches/volume in gallons). By way of example, after the whisky is placed in the bottle, the aging process stops, and the bottle is sold to the consumer. It was determined that the aging process may be continued, at least to some extent, by locating a portion of a used whisky barrel inside a whisky bottle along with the whisky. The portion of the used whisky barrel may be located in the bottle during bottling or subsequently by the purchaser of the bottle. In this manner, the whisky in the bottle will continue to age. This additional aging process tends to improve the quality of the whisky within the bottle over time, which is especially suitable for lower quality whisky that has been aged for a limited duration.

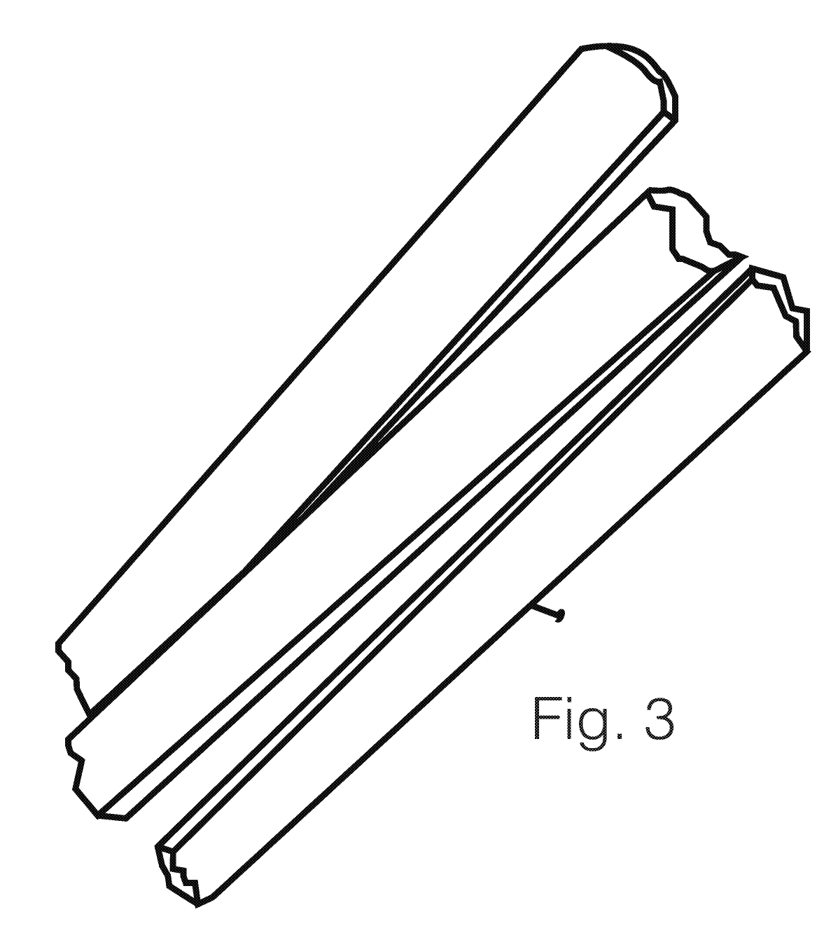

A used whisky barrel, after the whisky has been transferred to bottles, tends to still have chemicals therein that may be used to further age whisky. Referring to FIG. 3, a used whisky barrel may be cut into a set of smaller sticks. The sticks resulting from the cutting of the barrel are preferably have a diameter less than 1 inch at any particular location so that the stick may be located in a standard bottle. In addition, the sticks are preferably less than 12 inches in length so that they may fit within a whisky bottle. For example, the whisky bottle is preferably suitable to hold 500 ml to 1,500 ml of whisky while being substantially full. For example, a whisky bottle may have a surface area on the order of 80 square inches, and a surface to volume ratio of generally 2, for a 750 ml bottle (i.e. ˜45 in3, ˜0.1649 gallons). The surface to volume ratio of the cut whisky barrel stick is preferably selected to be on the order of the same surface to volume ratio as that of a whisky barrel. For example, the desired ratio may be 80 for a barrel having a volume of 26 gallons. In that case, the surface area of the stick for a whisky bottle may be generally ˜13 inches square (e.g., 0.1649 gallons *80 ratio). In that case, the surface area of the stick for a whisky bottle may be generally ˜18 inches square (e.g., 0.1649 gallons *110 ratio). Preferably, the surface area of the stick or sticks located in the bottle is within 75% (more preferably 50%, and more preferably 25%) of such a ratio of the surface area to the volume. A desirable range may be generally from 5 square inches to 25 square inches. More preferably, a desirable range may be generally from 10 to 20 square inches. More preferably, a desirable range may be generally from 13 to 17 square inches. Further, a plurality of sticks may be used within a single whiskey bottle to achieve such a desirable range.

The whisky bottle is selected that the drinker desires to age more, and thus improve its color and taste. The top of the whisky bottle is opened, and the selected cut barrel stick(s) are inserted into the whisky bottle, preferably with a suitable total surface area. The whisky bottle is then sealed and the whisky bottle is aged with the cut whisky barrel contained therein to improve its color and taste.

Another technique to achieve a deeper more complex spirit is to further age the whiskey in a barrel that was previously used to age wine. Such wine barrels may include, for example, a port or sauterne. In this manner, after the barrels used to age wine are emptied, some of the wine's essence remains in the wood. When those barrels are refilled with a spirit, the spirit chases those vinous characters out of the wood, adding subtle favors and colors to the spirit in the barrel. The resulting spirit from the wine barrel is then bottled.

In another embodiment, a used wine barrel, after the whisky has been transferred to bottles from the whiskey infused wine barrel, tends to still have chemicals therein that may be used to further age whisky. In another embodiment, a used wine barrel, where whisky has not been aged in the wine barrel, tends to still have chemicals therein that may be used to further age whisky. Accordingly, the wine barrel may be cut into a set of smaller sticks. The sticks resulting from the cutting of the barrel preferably have a diameter less than 1 inch at any particular location so that the stick may be located in a standard bottle. The resulting sick(s), sized as previously described with respect to a whiskey and/or wine barrel, may be located in the whiskey bottle to further age the whiskey.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/we claim:

1. A whisky bottle comprising:
(a) a whisky bottle having a volume of liquid whisky contained therein;
(b) at least one piece of wood cut from a used whisky barrel used to distill whiskey, where said at least one piece of wood have a total surface area thereof, where said total surface area thereof is selected based upon said volume of liquid;
(c) said at least one piece of wood located within said whisky bottle.

2. The whisky bottle of claim 1 wherein said whisky bottle is suitable to hold 500 ml to 1,500 ml of whisky while being substantially full.

3. The whisky bottle of claim 1 wherein said at least one piece is a single piece.

4. The whisky bottle of claim 1 wherein said at least one piece is a plurality of pieces.

5. The whisky bottle of claim 1 wherein each of said at least one piece has a largest diameter no greater than 1 inch.

6. The whisky bottle of claim 1 said selected is based upon a volume of a corresponding barrel from which said liquid whisky was aged.

7. The whisky bottle of claim 1 wherein a ratio of said total surface area to said volume of volume of liquid is within 75% of a total surface area of a corresponding barrel from which said liquid whisky was aged to a volume of said corresponding barrel.

8. The whisky bottle of claim 1 wherein a ratio of said total surface area to said volume of volume of liquid is within 50% of a total surface area of a corresponding barrel from which said liquid whisky was aged to a volume of said corresponding barrel.

9. The whisky bottle of claim 1 wherein a ratio of said total surface area to said volume of volume of liquid is within 25% of a total surface area of a corresponding barrel from which said liquid whisky was aged to a volume of said corresponding barrel.

10. The whisky bottle of claim 1 wherein said total surface area is between 5 inches square and 25 inches square.

11. The whisky bottle of claim 1 wherein said total surface area is between 10 inches square and 20 inches square.

12. The whisky bottle of claim 1 wherein said total surface area is between 13 inches square and 17 inches square.

13. A whisky bottle comprising:
(a) a whisky bottle having a volume of liquid whisky contained therein;
(b) at least one piece of wood cut from a used wine barrel used to at least one of distill whiskey and age wine, where said at least one piece of wood have a total surface area thereof, where said total surface area thereof is selected based upon said volume of liquid;
(c) said at least one piece of wood located within said whisky bottle.

14. The whisky bottle of claim 13 wherein said whisky bottle is suitable to hold 500 ml to 1,500 ml of whisky while being substantially full.

15. The whisky bottle of claim 13 wherein said at least one piece is a single piece.

16. The whisky bottle of claim 13 wherein said at least one piece is a plurality of pieces.

17. The whisky bottle of claim 13 wherein each of said at least one piece has a largest diameter no greater than 1 inch.

18. The whisky bottle of claim 13 said selected is based upon a volume of a corresponding wine barrel.

19. The whisky bottle of claim 13 wherein a ratio of said total surface area to said volume of volume of liquid is within 75% of a total surface area of a corresponding barrel to a volume of said corresponding barrel.

20. The whisky bottle of claim 13 wherein a ratio of said total surface area to said volume of volume of liquid is within 50% of a total surface area of a corresponding barrel to a volume of said corresponding barrel.

21. The whisky bottle of claim 13 wherein a ratio of said total surface area to said volume of volume of liquid is within 25% of a total surface area of a corresponding barrel to a volume of said corresponding barrel.

22. The whisky bottle of claim 13 wherein said total surface area is between 5 inches square and 25 inches square.

23. The whisky bottle of claim 13 wherein said total surface area is between 10 inches square and 20 inches square.

24. The whisky bottle of claim 13 wherein said total surface area is between 13 inches square and 17 inches square.
